(19) United States
(12) Patent Application Publication
(10) Pub. No.: US 2016/0169205 A1
(43) Pub. Date: Jun. 16, 2016

(54) METHOD FOR CONSTRUCTING WIND POWER CONNECTION SYSTEM MODEL BASED ON MEASURED DATA

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); JIN-PING ZHANG, Beijing (CN); KUN DING, Beijing (CN); SHI-YUAN ZHOU, Beijing (CN); JIN LI, Beijing (CN); LONG ZHAO, Beijing (CN); GUANG-TU LIU, Beijing (CN); RONG HUANG, Beijing (CN); DING-MEI WANG, Beijing (CN); QIANG ZHOU, Beijing (CN); LIANG LU, Beijing (CN); MING MA, Beijing (CN); JIAN-MEI ZHANG, Beijing (CN); QING-QUAN LV, Beijing (CN)

(21) Appl. No.: 14/565,445

(22) Filed: Dec. 10, 2014

(51) Int. Cl. F03D 11/00

(52) U.S. Cl. CPC F03D 11/0091

(57) ABSTRACT

A method of constructing wind power connection system model based on measured data includes following steps. Operating data is selected in a preset time of each wind turbine in a wind farm. A wind speed matrix and a active power matrix of sampling points are constructed based the operating data. A wind speed model of the wind farm is obtained based on the wind speed matrix and the active power matrix.

### BACKGROUND

1. Technical Field

The present disclosure relates to a method of constructing wind power connection system model based on measured data.

2. Description of the Related Art

With the rapid development of wind farm industry, the installed wind power capacity in the power network operation has reached 100 million kilowatts.

The wind power output is dependent on the wind speed. Thus the wind power output has following characteristics: random, uncontrollable, volatile, and small in unit capacity. Therefore, a large number of wind turbines often operate in parallel, and bring a certain impact to the operation stability of the power grid. In order to fully utilize wind resources, the establishment of appropriate models of wind turbines and wind farm to research on large-scale grid-connected wind farm has become particularly important. However, the traditional equivalent model of the wind farm cannot solve the problem of the dispersion of wind farms, and has large errors compared with the actual power output of wind farms.

What is needed, therefore, is a method of constructing wind power connection system model based on measured data that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flow chart of one embodiment of a method of constructing wind power connection system model based on measured data.

FIG. 2 shows a schematic view of one embodiment of a connection between the wind power and the power grid.

FIG. 3 shows a schematic view of one embodiment of a wind speed-power curve and a scatterplot of the wind turbines in practically operation.

FIG. 4 shows a schematic view of one embodiment of a scatterplot of average wind speed-power of the wind farm in the method of FIG. 1.

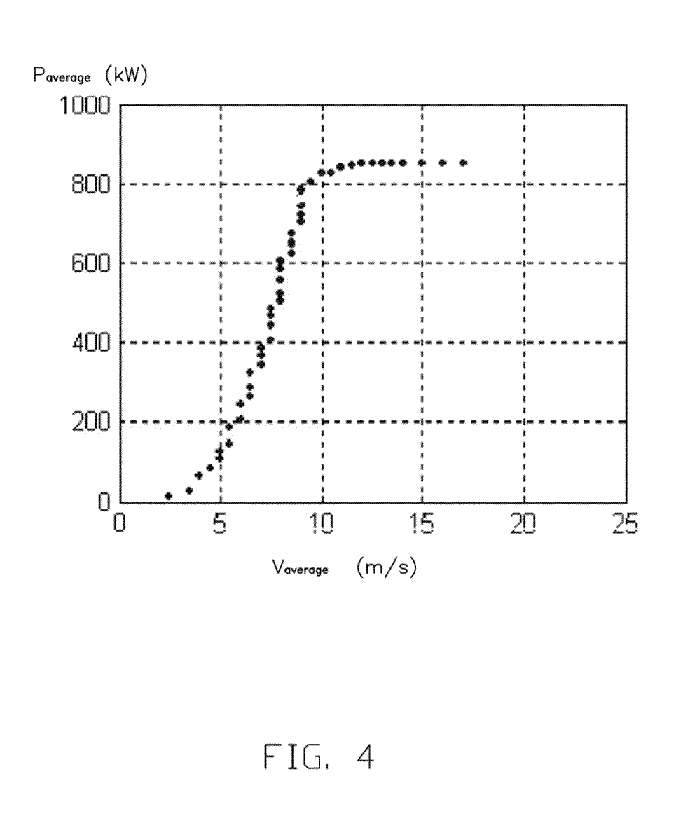

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

A method of constructing wind power connection system model based on measured data comprises:
step (a), selecting operating data in a preset time of each wind turbine in a wind farm;
step (b), constructing a wind speed matrix and a active power matrix of sampling points based the operating data; and
step (c), obtaining a wind speed model of the farm based on the wind speed matrix and the active power matrix.

Furthermore, the method further comprise following steps after step (c):
obtaining a curve of average wind speed to power characteristic based on the wind speed model of the farm;
taking the curve of average wind speed to power characteristic as a wind speed to power characteristic model of single wind turbine, and getting an output power of the single wind turbine via taking the average wind speed as an input wind speed of the single wind turbine;
obtaining output power of the wind farm by multiplying the output power by a total number of wind turbines operating in the wind farm:

P_{ref}=N×P=N×f(v);

wherein P_{ref} represents the output power of the wind farm, N is the number of the wind turbines in the wind farm, P is the output power of the single wind turbine, and f(v) is the input wind speed of the single wind turbine.

Furthermore, the wind speed matrix of sampling points in step (b) is:

$$v = [ \begin{matrix}{v}_{1 , 1} & {v}_{1 , 2} & … & {v}_{1 , n} \\ ⋮ & ⋮ & … & ⋮ \\ ⋮ & ⋮ & … & ⋮ \\ ⋮ & ⋮ & … & ⋮ \\ {v}_{k - 1 , 1} & {v}_{k - 1 , 2} & … & {v}_{k - 1 , n} \\ {v}_{k , 1} & {v}_{k , 2} & … & {v}_{k , n}\end{matrix} ] ,$$

wherein the i-th row represents the wind speed of the each of n wind turbines at the i-th sampling time, the j-th column indicates the wind speed of the j-th wind turbine at the i-th sampling time, and n is a natural number.

Furthermore, the active power matrix of sampling points in step (b) is:

$$P = [ \begin{matrix}{P}_{1 , 1} & {P}_{1 , 2} & … & {P}_{1 , n} \\ ⋮ & ⋮ & … & ⋮ \\ ⋮ & ⋮ & … & ⋮ \\ ⋮ & ⋮ & … & ⋮ \\ {P}_{k - 1 , 1} & {P}_{k - 1 , 2} & … & {P}_{k - 1 , n} \\ {P}_{k , 1} & {P}_{k , 2} & … & {P}_{k , n}\end{matrix} ]$$

wherein the i-th row represents the output powers of the n wind turbines at the i-th sampling time, the j-th column represents the output power of the j-th wind turbine at the i-th sampling time.

Furthermore, the step (c) comprises:
step (c1), calculating an average wind speed and an average power of the sampling points, and selecting the wind turbine which is nearest the wind energy distribution characteristics of the wind farm based on the wind speed matrix and the active power matrix;
step (c2), getting a scatter curve of the average wind peed to the average power of the wind farm based on the average wind speed and the average power;
step (c3), obtaining a wind speed model of the wind farm by taking the average wind speed of the wind turbine in the k-th sampling time:

$$v = \frac{1}{k} {\sum }_{i = 1}^{k} {v}_{i}$$

wherein vᵢ is a measured wind speed of the wind turbine which is nearest the wind energy distribution characteristics of the wind farm in i-th sampling time.

Furthermore, the step (c2) comprises:
step (c22), obtaining the scatter curve of the average wind peed to the average power of the wind farm by extracting k groups of wind speed to power (V_{i, average}, P_{i, average}) of the wind farm based on the average wind speed and the average power, wherein V_{i, average} is the average wind speed of the wind farm in the i-th sampling time, and P_{i, average} is the average power of the wind farm in the i-th sampling time, k is a natural number;
step (c23), getting a continuous curve representing a corresponding relationship between the average wind speed and the average power by dealing with the (V_{i, average}, P_{i, average}) via cubic spline interpolation, wherein the continuous curve is expressed as P_{average}=f(v_{average}).

Furthermore, in step (a), the operating data comprises all data of the wind turbines connected to the grid under all wind speeds in the preset time.

Furthermore, the all wind speeds in the preset time comprise the wind speed varies from 0 m/s to the rated wind speed.

Furthermore, the wind power connection system model comprise the single wind turbine which equivalent to the whole wind farm and ignoring the electrical connection between the wind turbines in the wind farm. The wind power connection system model further comprises a 0.69/35 kV transformer which equivalent to the combination of wind turbine and the box-type transformer, and a 35/330 kV which is connected to the grid. The single wind turbine is connected to the 35/330 kV transformer via 0.69/35 kV transformer.

Furthermore, the 0.69/35 kV is a 0.69/35 kV equivalent transformer. The 35/330 kV transformer is a 35/330 kV step-up transformer. The wind turbine is connected to the 0.69/35 kV transformer via a 35 kV overhead line. The 0.69/35 kV transformer is connected to a low voltage bus of the 35/330 kV transformer.

The method of constructing wind power connection system model utilize the average wind speed as the input of each wind turbine, the power fluctuations can be mitigated, and the difference of the wind farm output can be resolved. Thus the dispersion problems and large output power defects of the wind farm can be overcome.

### Embodiment

Because the actual working condition of the wind farm is varied, the output difference of each wind turbine is traced to the wind speed difference after considering the different wind condition of the wind turbine. The average output power is obtained by dealing with the wind speed of the wind turbine, and the output power of the wind turbines in the wind farm are accumulated to get the equivalent model of the wind farm.

In the embodiment, the establishing method of equivalent model of the wind farm, the connection of the wind turbines, and the connection between the wind turbine and the grid should be considered in the method of constructing wind power connection system model.

### Constructing Equivalent Model of Wind Farm

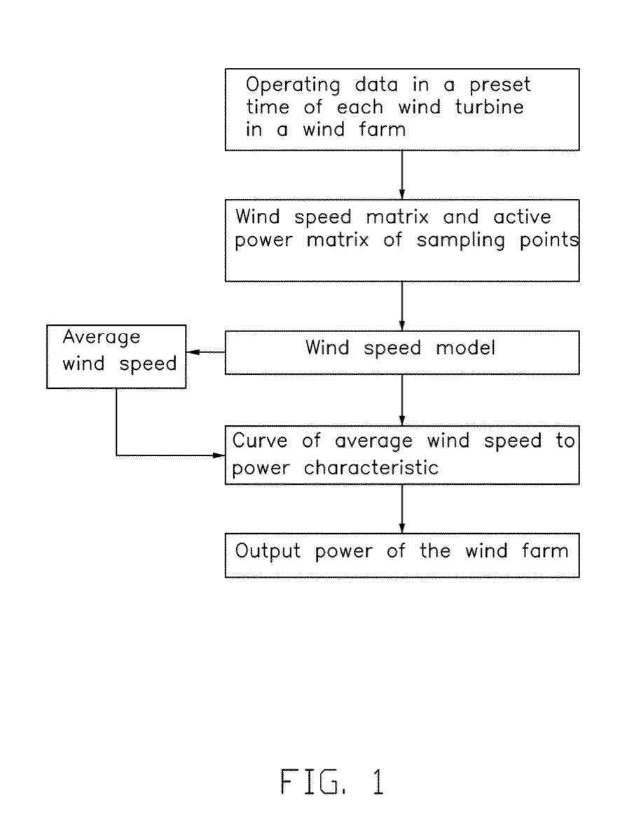

Referring to FIG. 1, the method of constructing equivalent model of wind farm comprises:
selecting operating data in a preset time of each wind turbine in a wind farm;
constructing a wind speed matrix and a active power matrix of sampling points based on the operating data;
obtaining a wind speed model of the farm by analyzing the wind speed matrix and the active power matrix, and getting a curve of a average wind speed to power characteristic, and the average wind speed of the wind farm based on the wind speed model; and
deducing output power of wind farm via inputting the average wind speed into the curve of average wind speed to power characteristic.

### Constructing a Connection of the Wind Turbines Inner the Wind Farm and a Connection between the Wind Farm and the Grid

The wind turbine in the wind farm are generally divided into ten or more groups, each of the wind turbine is connected to the 35 kV overhead line via a stand-along unit-linked variable 0.69/35 kV. The overhead line groups all the wind turbines in every group, and connected to a low voltage bus of the 35/330 kV transformer.

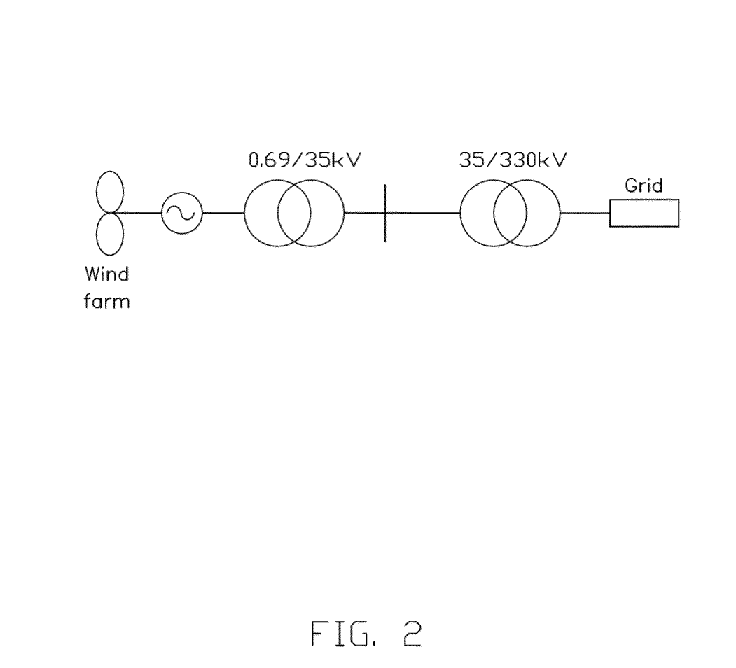

Referring to FIG. 2, the connection form between the wind turbines in the wind farm can be omitted. The whole wind farm can be equivalent to the single wind turbine. The combination of wind turbine and the box-type transformer is equivalent to a 0.69/35 kV transformer. Thus the equivalent wind farm is connected to the grid via the equivalent 0.69/35 kV transformer and the equivalent 35/330 kV transformer.

The wind power connection system model comprises the single wind turbine, the 0.69/35 kV transformer, and the 35/330 kV transformer. The single wind turbine is equivalent to the whole wind farm by ignoring the connection form between the wind turbines in the wind farm. The 0.69/35 kV transformer is equivalent to the combination of wind turbine and the box-type transformer. The single wind turbine is connected to the 35/330 kV transformer via the 0.69/35 kV transformer. The 0.69/35 kV transformer is an equivalent 0.69/35 kV transformer. The 35/330 kV transformer is the 35/330 kV step-up transformer. The single wind turbine is connected to the 35 kV overhead line via the 0.69/35 kV transformer. The 0.69/35 kV transformer is connected to the low voltage bus of the 35/330 kv transformer via the 35 kV cable.

Thus the single wind turbine can be considered as a two-port device and the average wind speed is taken as the input into the single wind turbine. The wind power connection system model considers the wind speed difference of the wind turbines in the wind farm, and avoids simulating each wind turbine in detail which leads to large computation.

The wind power connection system model can be used to analyze the grid-connection of the wind farm. In the simulation software, the wind turbine, the 0.69/35 kV transformer, 35/330 kV step-up transformer, and the connection between the wind farm and the grid can be simulated by the standard component models in the software library.

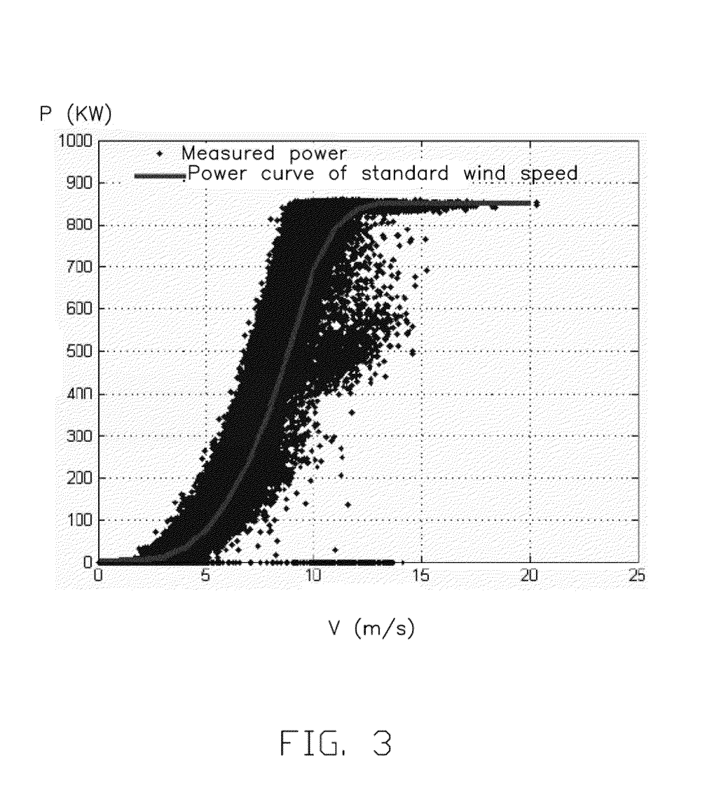

Referring to FIG. 3, the wind turbines operating in the grid often operate under the variable wind speed and wind direction. Furthermore, because of the limitation of the manufacturing process, there will be error while adopting the curve of the wind speed-power characteristic provided by the manufacturer in the constructing wind turbine model and analyzing operating characteristic. Therefore, in order to accurately analyze the wind speed-power characteristic, it is necessary to analyze the measured data of the wind farm to find out the true characteristic to reflect the relationship of wind speed-power characteristic.

Supposed that there are n wind turbines connected to the grid in the wind farm, thus the operating data of each wind turbines in the preset time are selected as sample data. The sample data can cover all the wind turbines connected to the grid under the wind speed ranging from about 0 m/s to the rated wind speed. The number of sampling points is k, and the sampling interval is 1 minute.

Thus the method of constructing wind power connection system model based on measured data comprises the following steps.

step (1), selecting operating data in a preset time of each wind turbine in a wind farm.

step (2), constructing a wind speed matrix and a active power matrix of sampling points based the operating data:

$$v = [ \begin{matrix}{v}_{1 , 1} & {v}_{1 , 2} & … & {v}_{1 , n} \\ ⋮ & ⋮ & … & ⋮ \\ ⋮ & ⋮ & … & ⋮ \\ ⋮ & ⋮ & … & ⋮ \\ {v}_{k - 1 , 1} & {v}_{k - 1 , 2} & … & {v}_{k - 1 , n} \\ {v}_{k , 1} & {v}_{k , 2} & … & {v}_{k , n}\end{matrix} ]$$

wherein the i-th row represents the wind speed of the each of n wind turbines at the i-th sampling time, the j-th column indicates the wind speed of the j-th wind turbine at the i-th sampling time, and n is a natural number.

step (3), obtaining a wind speed model of the farm based on the wind speed matrix and the active power matrix:

$$P = [ \begin{matrix}{P}_{1 , 1} & {P}_{1 , 2} & … & {P}_{1 , n} \\ ⋮ & ⋮ & … & ⋮ \\ ⋮ & ⋮ & … & ⋮ \\ ⋮ & ⋮ & … & ⋮ \\ {P}_{k - 1 , 1} & {P}_{k - 1 , 2} & … & {P}_{k - 1 , n} \\ {P}_{k , 1} & {P}_{k , 2} & … & {P}_{k , n}\end{matrix} ]$$

wherein the i-th row represents the output powers of the n wind turbines at the i-th sampling time, the j-th column represents the output power of the j-th wind turbine at the i-th sampling time.

step (4), calculating an average wind speed and an average power of the sampling points, and selecting the wind turbine which is nearest the wind energy distribution characteristics of the wind farm based on the wind speed matrix and the active power matrix.

step (5), obtaining the scatter curve of the average wind peed to the average power of the wind farm by extracting k groups of wind speed to power (V_{i, average}, P_{i, average}) of the wind farm based on the average wind speed and the average power, and getting a continuous curve representing a corresponding relationship between the average wind speed and the average power by dealing with the (V_{i,average}, P_{i, average}) via cubic spline interpolation, wherein the continuous curve is expressed as P_{average}=f(v_{average}), V_{i, average} is the average wind speed of the wind farm in the i-th sampling time, and P_{i, average} is the average power of the wind farm in the i-th sampling time, k is a natural number.

step (6), obtaining a wind speed model of the wind farm by taking the average wind speed of the wind turbine in the k-th sampling time:

$$v = \frac{1}{k} {\sum }_{i = 1}^{k} {v}_{i} ,$$

wherein vᵢ is a measured wind speed of the wind turbine which is nearest the wind energy distribution characteristics of the wind farm in i-th sampling time.

step (7), taking the curve of average wind speed to power characteristic as a wind speed to power characteristic model of single wind speed, getting an output power of the single wind turbine via taking the average wind speed as an input wind speed of the single wind turbine, and obtaining output power of the wind farm by multiplying the output power by a total number of wind turbines operating in the wind farm:

P_{ref}=N×P=N×f(v);

wherein P_{ref} represents the output power of the wind farm, N is the number of the wind turbines in the wind farm, P is the output power of the single wind turbine, and f(v) is the input wind speed of the single wind turbine.

The method of constructing wind power connection system model based on measured data has the following advantages. The method utilizes the wind speed model to calculate the average wind speed of the wind farm. In the wind speed model, the average wind speed is taken as the input of the single wind turbine. Thus the power fluctuation can be mitigated. The power output difference can be resolved. Furthermore, because the average wind speed is taken as the input, thus the output of the wind farm in the model is much closer to the actual output of the wind farm.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of constructing wind power connection system model based on measured data, the method comprising:
selecting operating data in a preset time of each wind turbine in a wind farm;
constructing a wind speed matrix and a active power matrix of sampling points based the operating data; and
obtaining a wind speed model of the wind farm based on the wind speed matrix and the active power matrix.

2. The method of claim 1, further comprising:
obtaining a curve of average wind speed to power characteristic based on the wind speed model of the farm;
taking the curve of average wind speed to power characteristic as a wind speed to power characteristic model of single wind turbine, and getting an output power of the single wind turbine via taking the average wind speed as an input wind speed of the single wind turbine;
obtaining output power of the wind farm by multiplying the output power by a total number of wind turbines operating in the wind farm:
P_{ref}=N×P=N×f(v);
wherein P_{ref} represents the output power of the wind farm, N is the number of the wind turbines in the wind farm, P is the output power of the single wind turbine, and f(v) is the input wind speed of the single wind turbine.

3. The method of claim 2, wherein the wind speed matrix of the sampling points is:
$$v = [ \begin{matrix}{v}_{1 , 1} & {v}_{1 , 2} & … & {v}_{1 , n} \\ ⋮ & ⋮ & … & ⋮ \\ ⋮ & ⋮ & … & ⋮ \\ ⋮ & ⋮ & … & ⋮ \\ {v}_{k - 1 , 1} & {v}_{k - 1 , 2} & … & {v}_{k - 1 , n} \\ {v}_{k , 1} & {v}_{k , 2} & … & {v}_{k , n}\end{matrix} ] ,$$
wherein the i-th row represents the wind speed of the each of n wind turbines at the i-th sampling time, the j-th column indicates the wind speed of the j-th wind turbine at the i-th sampling time, and n is a natural number.

4. The method of claim 2, wherein the active power matrix of the sampling points is:
$$P = [ \begin{matrix}{P}_{1 , 1} & {P}_{1 , 2} & … & {P}_{1 , n} \\ ⋮ & ⋮ & … & ⋮ \\ ⋮ & ⋮ & … & ⋮ \\ ⋮ & ⋮ & … & ⋮ \\ {P}_{k - 1 , 1} & {P}_{k - 1 , 2} & … & {P}_{k - 1 , n} \\ {P}_{k , 1} & {P}_{k , 2} & … & {P}_{k , n}\end{matrix} ]$$
wherein the i-th row represents the output powers of the n wind turbines at the i-th sampling time, the j-th column represents the output power of the j-th wind turbine at the i-th sampling time.

5. The method of claim 2, wherein obtaining a wind speed model of the farm comprises:
calculating the average wind speed and the average power of the sampling points, and selecting the wind turbine which nearest the wind energy distribution characteristics of the wind farm based on the wind speed matrix and the active power matrix;
getting a scatter curve of the average wind speed to the average power of the wind farm based on the average wind speed and the average power;
obtaining the wind speed model of the wind farm by taking the average wind speed of the wind turbine in the k-th sampling time:
$$v = \frac{1}{k} {\sum }_{i = 1}^{k} {v}_{i}$$
wherein vᵢ is a measured wind speed of the wind turbine which is nearest the wind energy distribution characteristics of the wind farm in i-th sampling time.

6. The method of claim 5, wherein getting a scatter curve of the average wind speed to the average power of the wind farm comprises:
obtaining the scatter curve of the average wind peed to the average power of the wind farm by extracting k groups of wind speed to power (V_{i, average}, P_{i, average}) of the wind farm based on the average wind speed and the average power, wherein V_{i, average} is the average wind speed of the wind farm in the i-th sampling time, and P_{i, average} is the average power of the wind farm in the i-th sampling time, k is a natural number;
getting a continuous curve representing a corresponding relationship between the average wind speed and the average power by dealing with the (V_{i, average}, P_{i, average}) via cubic spline interpolation, wherein the continuous curve is expressed as P_{average}=f(v_{average}).

7. The method of claim 1, wherein the operating data comprises all data of the wind turbines connected to the grid under all wind speeds in the preset time.

8. The method of claim 7, wherein the wind speed ranges from about 0 m/s to the rated wind speed.

9. The method of claim 2, wherein the wind power connection system model comprises the single wind turbine, a 0.69/35 kV transformer, and a 35/330 kV transformer; the single wind turbine is equivalent to the whole wind farm by ignoring a connection form between the wind turbines in the wind farm; the 0.69/35 kV transformer is equivalent to a combination of wind turbine and a box-type transformer; the single wind turbine is connected to the 35/330 kV transformer via the 0.69/35 kV transformer.

10. The method of claim 9, wherein the 0.69/35 kV transformer is an equivalent 0.69/35 kV transformer; the 35/330 kV transformer is the 35/330 kV step-up transformer; the single wind turbine is connected to a 35 kV overhead line via the 0.69/35 kV transformer; the 0.69/35 kV transformer is connected to a low voltage bus of the 35/330 kv transformer via a 35 kV cable.
